(19) United States
(12) Patent Application Publication
(10) Pub. No.: US 2005/0244690 A1
(43) Pub. Date: Nov. 3, 2005

(54) Fuel cell

(75) Inventors: Ken Iwai, Yokohama-shi (JP); Atsushi Fukunaka, Yokosuka-shi (JP)

Correspondence Address: FOLEY AND LARDNER;SUITE 500, 3000 K STREET NW, WASHINGTON, DC, 20007, US

(73) Assignee: NISSAN MOTOR CO., LTD.

(21) Appl. No.: 11/108,834

(22) Filed: Apr. 19, 2005

(30) Foreign Application Priority Data
Apr. 30, 2004 (JP) 2004-135629

(51) Int. Cl. H01M 8/04

(52) U.S. Cl. 429/26; 429/24; 429/13

(57) ABSTRACT

A fuel cell which includes unit cells stacked on one another, and a pair of end plates sandwitching the stacked unit cells therebetween. At least one of the end plates is provided with a catalyst combustor and a gas supply system to supply fuel gas and oxidant gas fed to the unit cells to the catalyst combustor.

### BACKGROUND OF THE INVENTION

1. Field of the Invention

The present invention relates to a fuel cell and, in particular, to technology for preventing voltage drop of a polymer electrolyte fuel cell (PEFC).

2. Description of Related Art

Fuel cells are electrochemical devices to convert chemical energy of fuel gas such as hydrogen gas and oxidant gas containing oxygen supplied thereto, directly to electric energy. Since the fuel cell generates electricity with high efficiency and low emissions, it has been applied to stationary power generation such as a power plant and a household generator and to a fuel-cell vehicle as a power source thereof.

Unit cell, component of the fuel cell, comprises a membrane electrode assembly (MEA) formed of a ion-exchanging solid polymer membrane, a fuel electrode provided on one side thereof and an oxidant electrode on the other side thereof; a separator provided on one side of MEA with a fuel gas channel formed on its surface in contact with the fuel electrode; and another separator on the other side of MEA with an oxidant gas channel formed on its surface in contact with the oxidant electrode. With the electrodes being supplied with the fuel gas and the oxidant gas, the unit cell generates electricity.

A fuel cell stack is a stack of the unit cells, in which a plurality of the unit cells are placed one on top of another. The fuel cell includes current collector plates, insulator plates, and end plates as sandwiching members disposed on both ends of the stack.

Since the current collector plates and end plates are comparatively excellent in thermal conductivity, heat of the stack is removed therethrough. Temperature distribution in the stack tends to be uneven with the middle section in a stack direction (a direction perpendicular to a plane of each unit cell) of the stack being higher in temperature and both ends thereof being lower in temperature, when starting the fuel cell. This uneven temperature distribution should be avoided since it causes unevenness in wetness of polymer membranes and in the electrochemical activity of an electrode catalyst among unit cells.

The fuel cell disclosed in Japanese Patent Application Laid-open Publication No. 8-167424 is provided, between a separator in the outermost unit cell thereof and a current collector plate abutting on the separator, with a heater of a resistive material being supplied with current from the fuel-cell stack. The heater allows the temperature distribution of the stack in the stack direction to be even by controlling the current for heat generation depending on amount of heat removed at the ends of the stack. The above-mentioned fuel cell has the following problem, especially in starting operation at extremely low temperature of 0° C. or below.

Decrease in efficiency of electricity generation is attributed to gradual increases in activation polarization, ohmic polarization, and concentration polarization caused by generated or transported water resulting from electrode reaction and transportation of protons (H+), in which the water progresses the wet of oxidant electrodes, gradually filling pores in the vicinity of the active sites of the electrode reaction.

In particular, at extremely low temperatures of 0° C. or below, the generated or transported water will be frozen on the interfaces of the electrodes. Continuous operation of the fuel cell under such an extremely low temperature condition causes more number of pores in the vicinity of the active sites in the oxidant electrode be filled with water, lowering the power generation capacity of the fuel cell.

Once the power generation capacity has decreased, it is difficult to restore to the initial state even if the fuel cell is operated under normal condition, which in turn requires a special reactivation process as disclosed in Japanese Patent Application Laid-open Publication No. 2003-272686, in which hydrogen-containing gas is supplied to an oxidant electrode, having current flow from a fuel electrode to the oxidant electrode via a power supply with the power generation thereof stopped.

### SUMMARY OF THE INVENTION

Using the above reactivation process, however, complicates configuration of the entire system. In addition, the supply of hydrogen-containing gas to the oxidant electrode may degrade electrode catalyst or catalyst-supporting carbon therein.

In general, when an operation of a fuel cell is stopped, immediately after a load is disconnected from the fuel cell and the supply of hydrogen and air to the fuel cell is stopped, temperature rises to about 70° C. to 100° C. and cell voltage reaches about 1.0 V/cell. Application of a voltage of as high as 0.8 V/cell or more to the cell in such a high temperature condition may cause carbon corrosion, and dissolution and condensation of noble metal particles in the oxidant electrode catalyst layer, which lower the catalytic activity.

A conceivable means for solving this problem is to consume oxidant gas left in the cell in stopping operation and to thereby lower the cell voltage. This, however, needs special valves and sensors and complicated control logics to control the supply of fuel gas and/or oxidant gas.

In the light of the above-mentioned problems, the present invention has been made to provide a fuel cell with improved power generation efficiency, preventing voltage drop thereof.

An aspect of the present invention is a fuel cell comprising: unit cells stacked on one another, each being adapted to generate power using fuel gas and oxidant gas supplied thereto; and a pair of sandwitching members sandwitching the stacked unit cells therebetween, wherein at least one of the sandwiching members is provided with a catalyst combustor and a gas supply system to supply the fuel gas and the oxidant gas to the catalyst combustor.

### BRIEF DESCRIPTION OF THE DRAWINGS

The invention will now be described with reference to the accompanying drawings wherein:

FIG. 1 is a schematic block diagram showing a polymer electrolyte fuel-cell system to which a fuel cell according to an embodiment of the present invention is applied;

FIG. 2 is a cross-sectional view of a fuel-cell stack in the fuel-cell system taken along line II-II of FIG. 1;

FIG. 3 is a partial cross section schematically showing the fuel cell of FIG. 1; and

FIG. 4 is a block diagram showing supply and discharge systems of fuel and oxidant gases of the fuel cell of FIG. 3.

### DETAILED DESCRIPTION OF THE PREFERRED EMBODIMENT

An embodiment of the present invention will be explained below with reference to the drawings, wherein like members are designated by like reference characters. A fuel cell to be described below may be applied to a polymer electrolyte fuel-cell system.

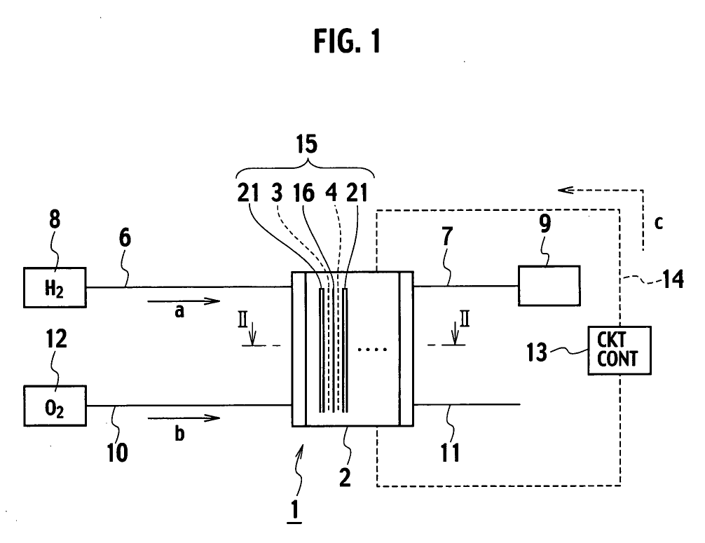

As shown in FIG. 1, a polymer electrolyte fuel cell 1 includes a fuel cell stack 2, in which fuel electrodes 3 and oxidant electrodes 4 are provided. A fuel supply line 6 and a fuel discharge line 7 are connected to the fuel electrodes 3. The fuel discharge line 7 discharges fuel gas unused in the reaction of the fuel cell. A hydrogen source 8 is provided on the fuel supply line 6. A hydrogen-containing gas treatment device 9 is provided on the fuel discharge line 7.

An oxidant supply line 10 and an oxidant discharge line 11 are connected to the oxidant electrodes 4 of the stack 2. The oxidant discharge line 11 discharges oxidant gas unused by the reaction of the fuel cell and water generated by the reaction. An oxidant source 12 is provided on the line 10. To the fuel electrodes 3 and the oxidant electrodes 4, a circuit controller 13 is connected through electrical wiring 14.

When the fuel cell 1 performs power generation, fuel gas and oxidant gas flow in the system, as shown in FIG. 1 by solid arrows “a” and “b”, respectively. The electric current flows as shown by a dashed arrow line “c”.

Fuel cell 1 has been so designed that hydrogen-containing gas as fuel gas is supplied from source 8 to the fuel electrodes 3 of the stack 2, and oxygen-containing gas as oxidant gas from source 12 to the oxidant electrodes 4, and then the controller 13 collects and outputs generated electricity.

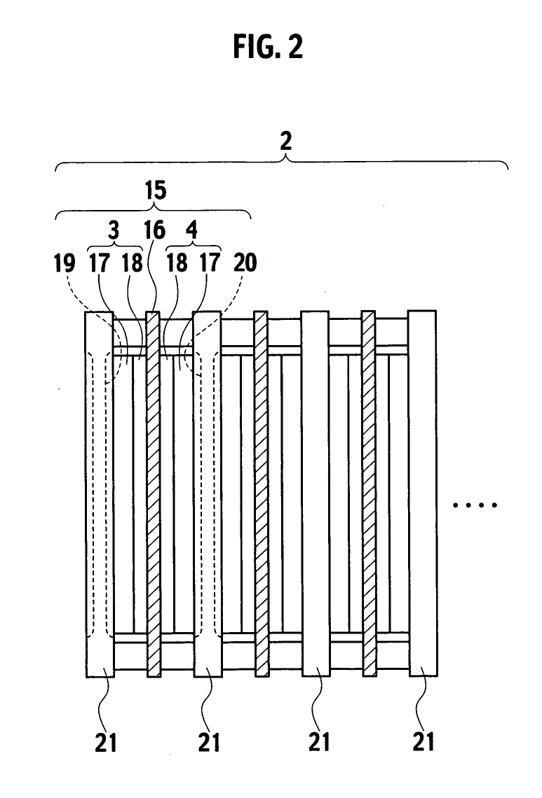

The stack 2 is formed, as shown in FIG. 2, with a plurality of unit cells 15 stacked one on top of another. Each unit cell 15 is provided with a membrane electrode assembly which consists of a solid polymer electrolyte membrane 16, a fuel electrode 3 provided on one side of membrane 16, and an oxidant electrode 4 on the other side thereof. Electrodes 3 and with protons (H+) 4 have respective catalyst layers 18 on their surfaces in contact with the membrane 16, and on the outside of layers 18, gas diffusion layers 17. Unit cell 15 comprises a separator 21 provided on one side of the membrane electrode assembly, which is formed to have a fuel gas channel 19 on the surface thereof in contact with the fuel electrode 3, and another separator 21 provided on the other side of the membrane electrode assembly, which is formed to have an oxidant gas channel 20 on the surface thereof in contact with electrode 4.

Unit cells 15 are stacked on one another in the stack 2 in such a manner that electrodes 3 and 4 are alternately arranged in a stack direction (a horizontal direction in FIG. 2, or a direction perpendicular to the plane of each unit cell 15). Gases supplied to electrodes 3 and 4 are separated by separators 21 interposed between unit cells 15.

Hydrogen-containing gas supplied through the line 6 in FIG. 1 to the stack 2 is distributed and fed to the channel 19 of each unit cell 15. Oxidant gas supplied through the line 10 in FIG. 1 to the stack 2 is distributed and fed to the channel 20 of each unit cell 15.

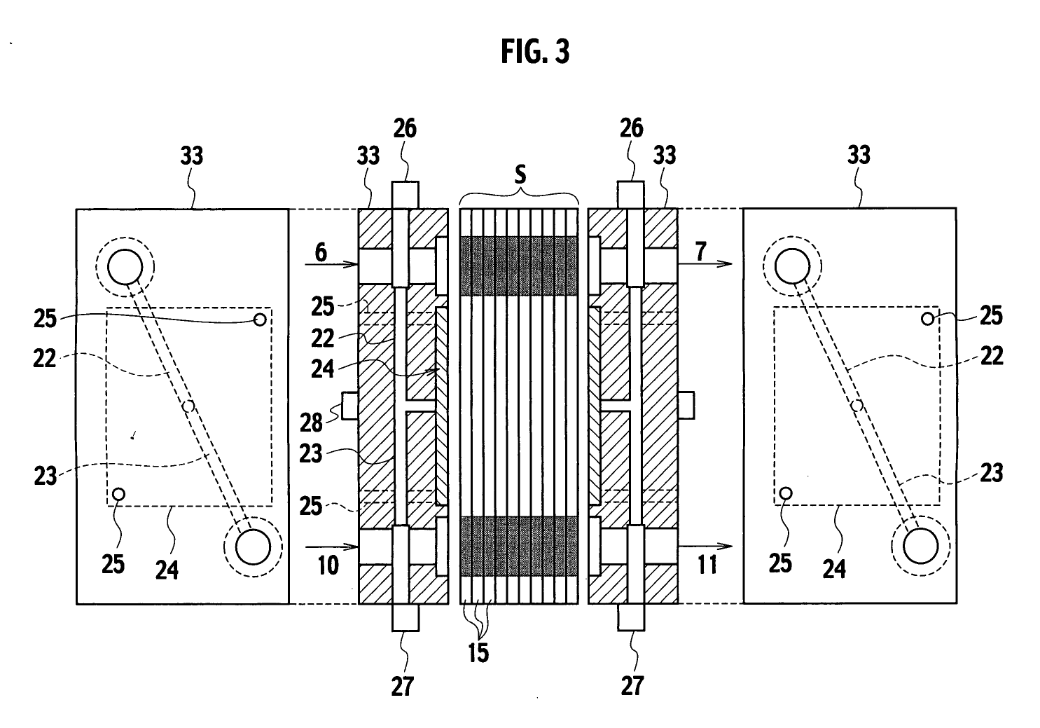

As shown in FIG. 3, the present embodiment further includes a pair of end plates 33 provided on both ends in the stack direction of the stack S. Each of the end plates 33 is provided on its surface in contact with the unit cell 15 positioned at an end of the stack S with a catalyst combustor 24 which includes catalysts and a substrate supporting the catalysts uniformly therein.

Each end plate 33 does not generate electricity by itself, but has at least one of the following three functions: collection of electricity generated by fuel cell stack 2; provision of an appropriate contact pressure to the unit cells 15, being pressed against the stack S in the stack direction; and as a manifold for the fuel gas and oxidant gas supplied through outside pipings, not shown, to the unit cells 15, which is realized by fuel and oxidant gas supply channels 22 and 23 as described below.

Each of the end plates 33 is provided with the fuel gas supply channel 22 to take hydrogen-containing gas from the fuel supply line 6 and feed to the catalyst combustor 24, the oxidant gas supply channel 23 to take oxygen-containing gas from the oxidant supply line 10 and feed to the catalyst combustor 24, and a discharge channel 25 to discharge water or water vapor generated by catalyst combustion in the catalyst combustor 24.

Further, each end plate 33 is provided with a fuel gas switching valve 26 to control flow rate of hydrogen-containing gas from the line 6, an oxidant gas switching valve 27 to control flow rate of oxygen-containing gas from the line 10, and a temperature sensor 28 to detect temperature of the unit cells 15 positioned at an end of the stack 2 in the stacking direction for determining if heating operation is needed.

In starting the fuel cell 1 at a temperature of, for example, 0° C. or lower, the hydrogen-containing gas is supplied through the fuel supply line 6 to the fuel cell 1, and the oxygen-containing gas through the oxidant supply line 10 to the fuel cell 1. At this point, the fuel gas switching valve 26 is controlled to supply the hydrogen-containing gas to the fuel gas supply channel 22 and the fuel gas channel 19 in the fuel cell 1, and the oxidant gas switching valve 27 is controlled to supply the oxygen-containing gas only to the oxidant gas supply channel 23, but not to the oxidant gas channel 20 in the fuel cell 1. It is not always necessary to supply the hydrogen-containing gas to the fuel gas channel 19. It is preferable, however, not to supply the oxygen-containing gas to the oxidant gas channel 20.

In this state, the hydrogen-containing gas and the oxygen-containing gas are supplied to the catalyst combustor 24. The hydrogen-containing gas reacts to combust with the oxygen-containing gas on the catalyst supported on the substrate in the catalyst combustor 24. The reaction heat of the combustion is then transferred to the unit cells 15 positioned at both ends of the stack S of the fuel cell 1, increasing in their temperatures. When a temperature detected by the temperature sensor 28 reaches a predetermined value, the oxidant gas switching valve 27 is controlled to supply the oxidant gas to the oxidant gas channel 20, starting the generation of electricity.

When it is confirmed from a detected value of the temperature sensor 28 that a temperature of unit cells 15 positioned at both ends of the stack S has reached a predetermined value, the valve 26 is controlled to stop the supply of the hydrogen-containing gas to the fuel gas supply channel 22, and at the same time, the valve 27 is controlled to stop the supply of the oxygen-containing gas to the oxidant gas supply channel 23.

As described above, according to the fuel cell of the present embodiment, the hydrogen-containing gas and the oxygen-containing gas are supplied to the catalyst combustors 24 provided on both end plates 33 and react with each other on the catalyst in the catalyst combustor 24 to release combustion heat. The combustion heats are transferred from the catalyst combustors 24 to the unit cells 15 positioned at both ends of stack S, whereby temperature decrease of the unit cells 15 is suppressed, providing an even temperature distribution of the stack S in the stack direction. Problems relating to activation polarization and concentration polarization will not be raised, since no electric current is extracted from the fuel cell during the heating operation of the unit cells 15 positioned at both ends of the stack S. This can prevent the electrodes 4 from getting flooded with water generated by the electrode reaction and transported from the fuel electrode 3 with protons (H+), and pores of the catalyst layer 18 thereof in the vicinity of the active sites of the electrode reaction from being gradually filled with water, avoiding decrease in voltage across the fuel cell 1, which improves efficiency in the electricity generation.

The fuel cell 1 of the present embodiment can positively discharges water or water vapor and by-products generated in the catalyst combustor 24 outside through the discharge channel 25, keeping performance of the catalyst combustor 24 high in increasing temperature condition.

According to the fuel cell of the present embodiment, an excessive rise in temperature and deterioration of the catalysts can be suppressed by virtue of the temperature sensor 28 for detecting the temperature of the unit cells 15.

The preferred embodiment described herein is illustrative and not restrictive, and the invention may be practiced or embodied in other ways without departing from the spirit or essential character thereof.

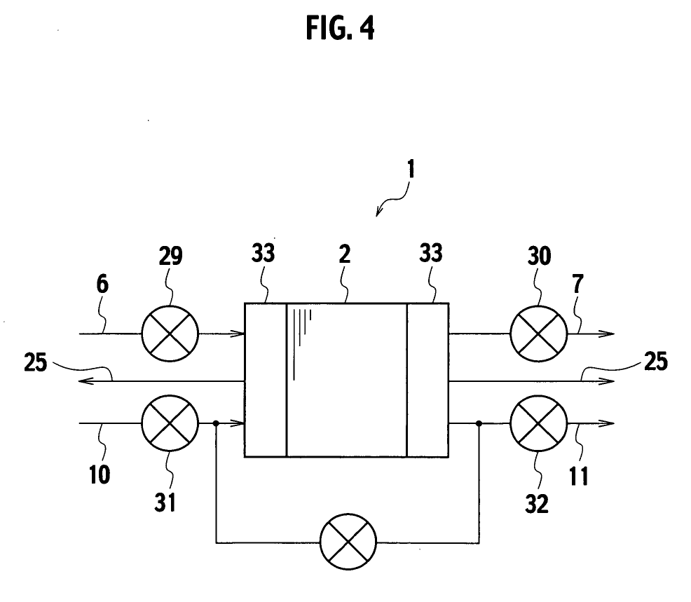

For example, as shown in FIG. 4, lines 6, 7, 10, and 11 to/from the stack 2 may be provided with fuel supplying-line valve 29, fuel discharging-line valve 30, oxidant supplying-line valve 31, and oxidant discharging-line valve 32, respectively.

Keeping these line valves 29, 30, 31, and 32 closed with the gas switching valves 26 and 27 open when stopping the fuel cell 1, the hydrogen-containing gas and the oxygen-containing gas left in the stack 2 can react with each other in the catalyst combustor 24. This allows the hydrogen-containing gas and the oxygen-containing gas left in the gas channels 19 and 20 of the stack 2 to be surely consumed, and cell voltage to be quickly lowered, thereby suppressing the deterioration of the electrode catalyst.

The scope of the invention being indicated by the claims, and all variations which come within the meaning of claims are intended to be embraced herein.

The present disclosure relates to subject matters contained in Japanese Patent Application No. 2004-135629, filed on Apr. 30, 2004, the disclosure of which is expressly incorporated herein by reference in its entirety.

1. A fuel cell comprising:
unit cells stacked on one another, each being adapted to generate power using fuel gas and oxidant gas supplied thereto; and
a pair of sandwitching members sandwitching the stacked unit cells therebetween, wherein
at least one of the sandwiching members is provided with a catalyst combustor and a gas supply system to supply the fuel gas and the oxidant gas to the catalyst combustor.

2. A fuel cell according to claim 1, wherein
the gas supply system comprises a fuel gas supply channel for supplying the fuel gas to the catalyst combustor, provided with a valve for controlling flow rate of the fuel gas, and an oxidant gas supply channel for supplying the oxidant gas to the catalyst combustor, provided with a valve for controlling flow rate of the oxidant gas.

3. A fuel cell according to claim 2, wherein
the sandwiching member is provided with a water discharge channel for discharging water or water vapor generated in the catalyst combustor.

4. A fuel cell according to claim 1, wherein
the sandwiching member is provided with a temperature sensor for detecting temperatures of the unit cells.

5. A fuel cell according to claim 2, further comprising:
a gas discharge system to discharge the fuel gas and the oxidant gas from the catalyst combustor, which comprises
a gas discharge channel for discharging the fuel gas and the oxidant gas, and a valve provided thereon, wherein the valves of the gas supply system and the gas discharge system are adapted to be individually closable.

6. A method for controlling temperature distribution of a fuel cell which comprises unit cells stacked on one another, each being adapted to generate power using fuel gas supplied thereto, the method comprising:
heating the unit cells using catalyst combustion of the fuel gas.

7. A fuel cell comprising:
unit cells stacked on one another, each being adapted to generate power using fuel gas and oxidant gas supplied thereto; and
a pair of sandwitching members sandwitching the stacked unit cells therebetween, wherein
at least one of the sandwiching members is provided with means for heating the stacked unit cells using the fuel gas and the oxidant gas.
